(19) United States
(12) Patent Application Publication
(10) Pub. No.: US 2014/0184677 A1
(43) Pub. Date: Jul. 3, 2014

(54) INK JET PRINTING

(71) Applicant: FUJIFILM Dimatix, Inc., Lebanon, NH (US)

(72) Inventors: Paul A. Hoisington, Hanover, NH (US); Deane A. Gardner, Cupertino, CA (US)

(73) Assignee: FUJIFILM Dimatix, Inc., Lebanon, NH (US)

(21) Appl. No.: 14/202,029

(22) Filed: Mar. 10, 2014

Related U.S. Application Data
(63) Continuation of application No. 11/321,941, filed on Dec. 29, 2005, now Pat. No. 8,708,441.
(60) Provisional application No. 60/640,538, filed on Dec. 30, 2004.

(51) Int. Cl. B41J 2/045

(52) U.S. Cl. CPC B41J 2/04588
USPC 347/11

(57) ABSTRACT

In general, in one aspect, the invention features a method of driving an inkjet module having a plurality of ink jets. The method includes applying a voltage waveform to the inkjet module, the voltage waveform including a first pulse and a second pulse, activating one or more of the ink jets contemporaneously to applying the first pulse, wherein each activated ink jet ejects a fluid droplet in response to the first pulse, and activating all of the ink jets contemporaneously to applying the second pulse without ejecting a droplet.

### CROSS-REFERENCE TO RELATED APPLICATIONS

This application claims priority to Provisional Application No. 60/640,538, entitled “INK JET PRINTING,” filed on Dec. 30, 2004, the entire contents of which is incorporated herein by reference.

### TECHNICAL FIELD

This disclosure relates to ink jet printing.

### BACKGROUND

Inkjet printers are one type of apparatus employing droplet ejection devices. In one type of inkjet printer, ink drops are delivered from a plurality of linear inkjet print head devices oriented perpendicular to the direction of travel of the substrate being printed. Each print head device includes a plurality of droplet ejection devices formed in a monolithic body that defines a plurality of pumping chambers (one for each individual droplet ejection device) in an upper surface and has a flat piezoelectric actuator covering each pumping chamber. Each individual droplet ejection device is activated by a voltage pulse to the piezoelectric actuator that distorts the shape of the piezoelectric actuator and discharges a droplet at the desired time in synchronism with the movement of the substrate past the print head device.

Each individual droplet ejection device is independently addressable and can be activated on demand in proper timing with the other droplet ejection devices to generate an image. Printing occurs in print cycles. In each print cycle, a fire pulse (e.g., 10-150 volts) is applied to all of the droplet ejection devices at the same time, and enabling signals are sent to only the individual droplet ejection devices that are to jet ink in that print cycle.

### SUMMARY

In general, in one aspect, the invention features a method of driving an inkjet module having a plurality of ink jets. The method includes applying a voltage waveform to the inkjet module, the voltage waveform including a first pulse and a second pulse, activating one or more of the ink jets contemporaneously to applying the first pulse, wherein each activated ink jet ejects a fluid droplet in response to the first pulse, and activating all of the ink jets contemporaneously to applying the second pulse without ejecting a droplet.

Embodiments of this aspect of the invention may include one or more of the following features. Each ink jet comprises a piezoelectric transducer. Activating an ink jet causes the voltage waveform to be applied to the piezoelectric transducer for that ink jet. Activating all of the ink jets contemporaneously causes a fluid meniscus in each ink jet to move in response to the second pulse without ejecting a droplet.

The method may further include applying additional voltage waveforms to the inkjet module, the voltage waveforms being applied with a frequency of about 2 kHz or more. The first pulse has a first period and the second pulse has a second period less than the first period. The first pulse has a first amplitude and the second pulse has a second amplitude less than the first amplitude.

In another aspect of the invention, a method of driving an inkjet module having a plurality of ink jets comprises applying a voltage waveform to an ink jet in the inkjet module each period in a jetting cycle, wherein each cycle the voltage waveform comprises a first pulse or a second pulse. The first pulse causes the ink jet to eject a fluid droplet and the second pulse causes a fluid meniscus in the ink jet to move without ejecting a droplet.

Embodiments of this aspect of the invention may include one or more of the following features. Each period of the voltage waveform includes either the first pulse or the second pulse. The second pulse is applied to the ink jet contemporaneously to applying the first pulse to other ink jets in the inkjet module. In a further aspect of the invention, a system comprises an inkjet module including a plurality of ink jets; and an electronic controller configured to deliver a voltage waveform to at least one of the ink jets in the inkjet module each period of a jetting cycle, the voltage waveform comprising a first pulse or a second pulse, the first pulse causing the ink jet to eject a fluid droplet and the second pulse causing a fluid meniscus in the ink jet to move without ejecting a droplet.

Embodiments of this aspect of the invention may include one or more of the following features. Each ink jet comprises a piezoelectric transducer. The inkjet module comprises control circuitry configured to activate the ink jets so that the electronic controller applies the drive waveform to activated ink jets but not to ink jets that are not activated. The control circuitry is configured to activate all of the ink jets contemporaneously to applying the second pulse to the inkjet module. The electronic controller is configured to deliver the same drive waveform to each activated ink jet. Alternatively, the electronic controller is configured to deliver different drive waveforms to different ink jets. In some embodiments, the inkjet module comprises 16 or more ink jets. A pulse that causes the fluid meniscus in an each ink jet to move in response to the pulse without ejecting a droplet is referred to herein as a “tickle pulse.” The voltage waveform can be applied to the ink jet module periodically, corresponding to each jetting cycle of the module.

Embodiments of the method and system described above can include one or more of the following advantages. Applying a tickle pulse to each ink jet each jetting cycle can reduce the effects of fluid evaporation from a nozzle of each ink jet, and can prevent, or at least reduce, the chance that a nozzle will dry out. This can be particularly advantageous when jetting highly volatile fluids (e.g., solvent-based inks) and/or when an ink jet remains inactive for an extended period of time during operation. Increasing jet “open time” (i.e., the length of time an inactive jet remains capable of optimal jetting before drying out) can improve reliability of printheads utilizing ink jet modules, particularly during jetting operations where one or more nozzle remains inactive for an extended period.

In embodiments, tickle pulses can be applied to each jet each cycle with little (if any) modification to drive electronics. The tickle pulse can be effectuated by modifying the drive waveform and the timing of an “all on” signal, which activates all ink jets in a module.

The details of one or more embodiments of the invention are set forth in the accompanying drawings and the description below. Other features and advantages of the invention will be apparent from the description and drawings, and from the claim.

### DESCRIPTION OF DRAWINGS

FIG. 1 is a schematic diagram of an embodiment of a printhead.

FIG. 2A is a cross-sectional view of an embodiment of an ink jet.

FIG. 2B is a cross-sectional view of an actuator of the ink jet shown in FIG. 2A.

FIG. 3A is an example of a waveform cycle.

FIG. 3B is a logic signal for activating selected jets corresponding to the waveform cycle shown in FIG. 3A.

FIG. 3C is a logic signal for non-selected jets corresponding to the waveform cycle shown in FIG. 3A.

FIG. 3D is an all-on logic signal corresponding to the waveform cycle shown in FIG. 3A.

FIG. 4A is an example of a waveform cycle.

FIG. 4B is a logic signal for activating selected jets corresponding to the waveform cycle shown in FIG. 4A.

FIG. 4C is a logic signal for non-selected jets corresponding to the waveform cycle shown in FIG. 4A.

FIG. 5A is an example of a waveform cycle for selected jets.

FIG. 5B is an example of a waveform cycle for non-selected jets.

### DETAILED DESCRIPTION

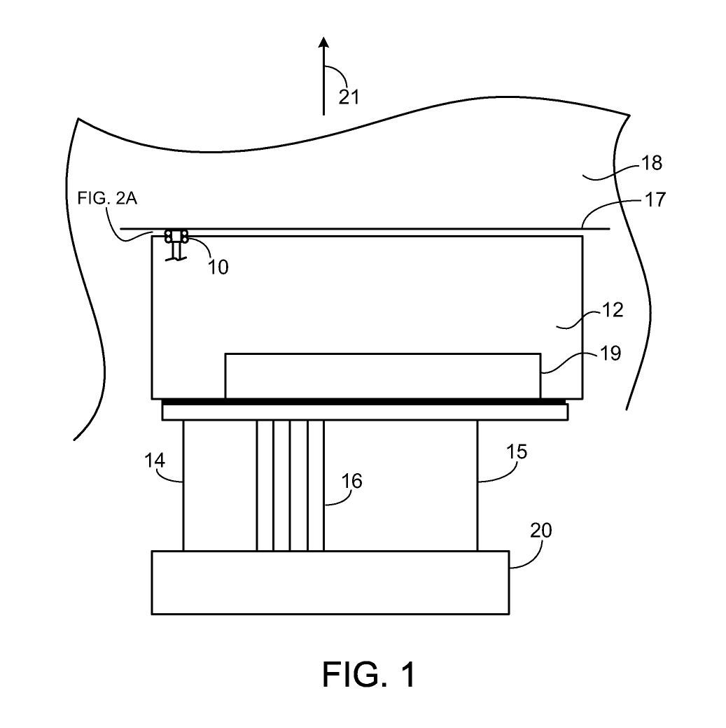

Referring to FIG. 1, an ink jet module 12 includes multiple (e.g., 16, 64, 128, 256, 512 or more) ink jets 10 (only one is shown on FIG. 1), which are driven by electrical drive pulses provided over signal lines 14 and 15 and distributed by on-board control circuitry 19 to control firing of ink jets 10. An external controller 20 supplies the drive pulses over lines 14 and 15 and provides control data and logic power and timing over additional lines 16 to on-board control circuitry 19. Ink jetted by ink jets 10 can be delivered to form one or more print lines 17 on a substrate 18 that moves relative to ink jet module 12 (e.g., in the direction indicated by arrow 21). In some embodiments, substrate 18 moves past a stationary print head module 12 in a single pass mode. Alternatively, ink jet module 12 can also move across substrate 18 in a scanning mode.

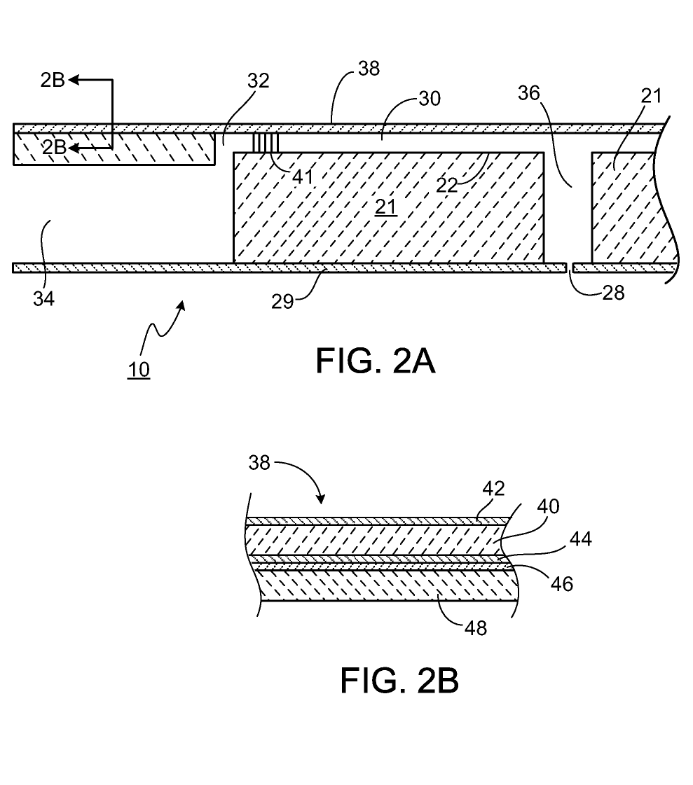

Referring to FIG. 2A (which is a diagrammatic vertical section), each ink jet 10 includes an elongated pumping chamber 30 in an upper face of a semiconductor block 21 of print head 12. Pumping chamber 30 extends from an inlet 32 (from a source of ink 34 along the side) to a nozzle flow path in a descender passage 36 that descends from an upper surface 22 of block 21 to a nozzle 28 opening in a lower layer 29. The nozzle size may vary as desired. For example, the nozzle can be on the order of a few microns in diameter (e.g., about 5 microns, about 8 microns, 10 microns) or can be tens or hundreds of microns in diameter (e.g., about 20 microns, 30 microns, 50 microns, 80 microns, 100 microns, 200 microns or more). A flow restriction element 41 is provided at the inlet 32 to each pumping chamber 30. In some embodiments, flow restriction element 41 includes a number of posts in inlet 32. A flat piezoelectric actuator 38 covering each pumping chamber 30 is activated by drive pulses provided from line 14, the timing of which are controlled by control signals from on-board circuitry 19. The drive pulses distort the piezoelectric actuator shape and thus vary the volume in chamber 30 drawing fluid into the chamber from the inlet and forcing ink through the descender passage 36 and out the nozzle 28. Each print cycle, multipulse drive waveforms are delivered to activated jets, causing each of those jets to eject a single droplet from its nozzle at a desired time in synchronism with the relative movement of substrate 18 past the print head device 12.

During operation, controller 20 supplies a periodic waveform to ink jet module 12. One period of the waveform can include one or more pulses. Controller 20 also provides logic signals that activate or deactivate individual ink jets. When an ink jet is activated, controller 20 applies the waveform to the ink jet's piezoelectric actuator.

Referring also to FIG. 2B, flat piezoelectric actuator 38 includes a piezoelectric layer 40 disposed between a drive electrode 42 and a ground electrode 44. Ground electrode 44 is bonded to a membrane 48 (e.g., a silica, glass or silicon membrane) by a bonding layer 46. When the ink jet is activated, the waveform generates an electric field within piezoelectric layer 40 by applying a potential difference between drive electrode 42 and ground electrode 44. Piezoelectric layer 40 distorts actuator 38 in response to the electric field, thus changing the volume of chamber 30. The volume change causes pressure waves in fluid in chamber 30. Depending on the amplitude and/or period of the waveform pulse applied to the actuator, these pressure waves can cause the ink jet to eject a droplet from its nozzle, or can excite the fluid meniscus in the nozzle without ejecting a droplet.

In general, each cycle of the periodic waveform includes a first pulse and a second pulse. The first pulse has a sufficiently large amplitude and/or period to cause an activated ink jet to eject a fluid droplet. This pulse is also referred to as an ejection pulse. The second pulse is a tickle pulse and has an amplitude and/or period insufficient to cause an activated ink jet to eject a droplet. For each cycle of the periodic waveform, controller 20 activates selected jets during the first pulse, causing each of the selected ink jets to eject a droplet. Controller 20 activates all the ink jets during the second pulse.

The second pulse causes motion of a meniscus in each jet nozzle. Where the meniscus has receded due to, e.g., evaporation of the fluid from the nozzle, the tickle pulse can restore the meniscus to the position it would assume after jetting a droplet. Accordingly, after each cycle, the position of the meniscus in each nozzle can be substantially the same, regardless of whether or not the jet was activated for that cycle.

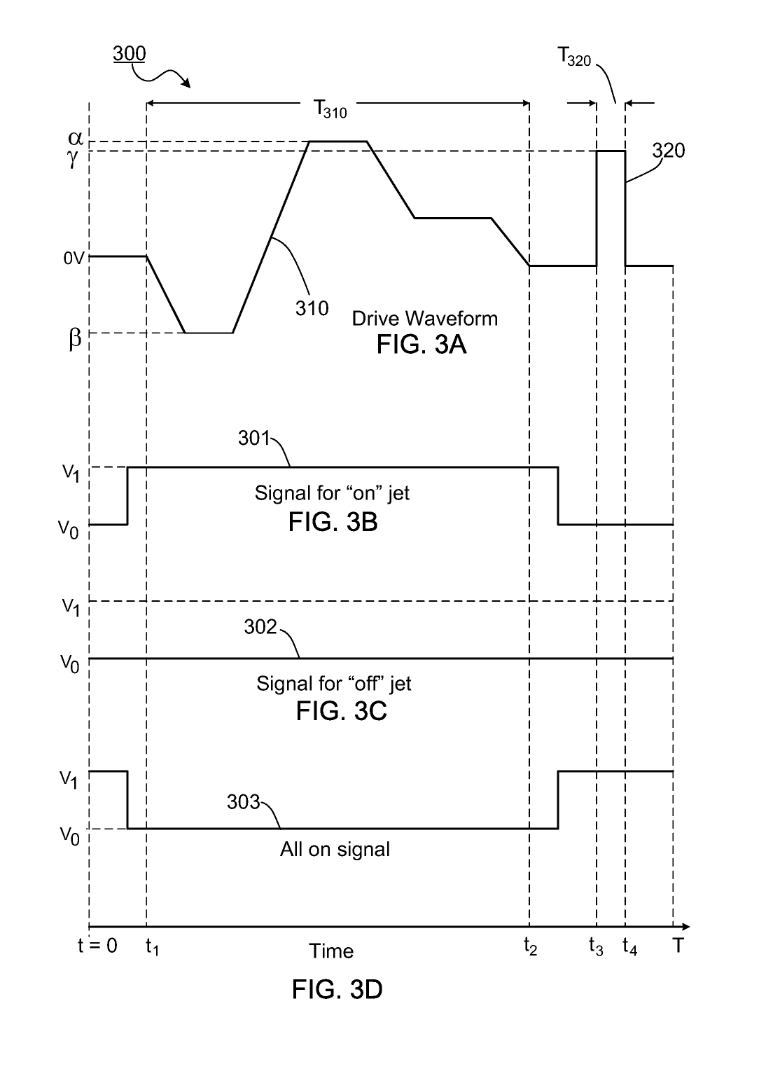

Referring to FIG. 3A, an example of a waveform is waveform 300. Each cycle of waveform 300 includes a first pulse 310 and a second pulse 320. A cycle of waveform 300 begins at t=0. Pulse 310 begins at time t₁ and ends at time t₂. Pulse 310 has a period, T₃₁₀, equal to t₂-t₁. Pulse 320 begins at time t₃, some time after t₂, and ends at time t₄. Pulse 320 has a period, T₃₂₀, equal to t₄-t₃. The cycle has a period T and repeats while the ink jet module is jetting.

Pulse 310 is a bipolar pulse that includes a first trapezoidal portion of negative voltage followed by a second portion having positive voltage. The trapezoidal portion has a minimum voltage of β, which is maintained for a period. The second portion has a maximum voltage of α, also held for a period. The voltage is then reduced to an intermediate positive voltage that is held for a period before the pulse ends.

The shape of pulse 310, α, β, and T₃₁₀ are selected so that an activated ink jet driven by pulse 310 ejects a droplet of a predetermined volume. β can be about −5 V or less (e.g., about −10 V or less, about −15 V or less, about −20 V or less). α can be about 5 V or more (about 10 V or more, about 20 V or more, about 30 V or more, about 40 V or more, about 50 V or more, about 60 V or more, about 70 V or more, about 80 V or more, about 90 V or more, about 100 V or more). In some embodiments, α-β can be about 30 V or more (e.g., about 40 V or more, about 50 V or more, about 60 V or more, about 70 V or more, about 80 V or more, about 90 V or more, about 100 V or more, about 110 V or more, about 120 V or more, about 130 V or more, about 140 V or more, about 150 V or more). Generally, T₃₁₀ is within a range from about 1 μs and about 100 μs (e.g., about 2 μs or more, about 5 μs or more, about 10 μs or more, about 75 μs or less, about 50 μs or less, about 40 μs or less).

Pulse 320 is a unipolar, rectangular pulse that has a maximum amplitude of γ. In general, γ and T₃₂₀ are selected so that activated ink jets driven by pulse 320 do not eject droplets, but still experience a pressure wave causing the position of the meniscus to vibrate in each activated jets nozzle. γ can be the same or different from β. In some embodiments, γ is about 100 V or less (e.g., about 90 V or less, about 80 V or less, about 70 V or less, about 60 V or less, about 50 V or less, about 40 V or less, about 30 V or less, about 20 V or less). T₃₂₀ can be about 20 μs or less (e.g., about 15 μs or less, about 10 μs or less, about 8 μs or less, about 5 μs or less, about 4 μs or less, about 3 μs or less, about 2 μs or less, about 1 μs or less).

In embodiments, T is in a range from about 20 μs to about 500 μs, corresponding to a range of jetting frequencies from about 50 kHz to about 2 kHz. For example, in some embodiments, T corresponds to a jetting frequency of about 5 kHz or more (e.g., about 10 kHz or more, about 15 kHz or more, about 20 kHz or more, about 25 kHz or more, about 30 kHz or more).

Logic signals corresponding to waveform 300 are shown in FIGS. 3B-3D. The logic signals are binary pulses, corresponding to two different voltage levels. A first state, at voltage V₀, causes an ink jet to be deactivated. In the other state, at voltage V₁, an ink jet is activated.

Referring specifically to FIG. 3B, a logic signal 301 is used to activate selected jets for jetting. Signal 301 switches from V₀ to V₁ at some time after t=0 but before t₁. Accordingly, the jet is activated prior to t₁, when pulse 310 is applied. Signal 301 switches back to V₀ at some time after t₂, but before t₃.

Referring to FIG. 3C, in the event that a jet is not activated, a logic signal 302 is used. Logic signal 302 does not change from V₀, so that the corresponding jet is not activated.

Referring to FIG. 3C, a third logic signal 303 is applied to all the jets in the ink jet module each cycle. Signal 303 switches from V₁ to V₀ prior to t₁, so that no jets are activated by signal 303 when pulse 310 is applied. However, between t₂ and t₃, signal 303 switches back to V₁, so that all jets are activated by t₃. This causes the controller to apply pulse 320 to all jets each cycle.

While in the foregoing embodiment, every ink jet in the module is activated for a tickle pulse every drive cycle regardless of whether the ink jet is activated for an ejection pulse, other implementations are also possible. For example, in some embodiments, each drive cycle, each ink jet can be activated either by a drive waveform or a tickle pulse. In other words, in each drive cycle, those ink jets that are not activated for the ejection pulse are activated for the tickle pulse, and vice versa.

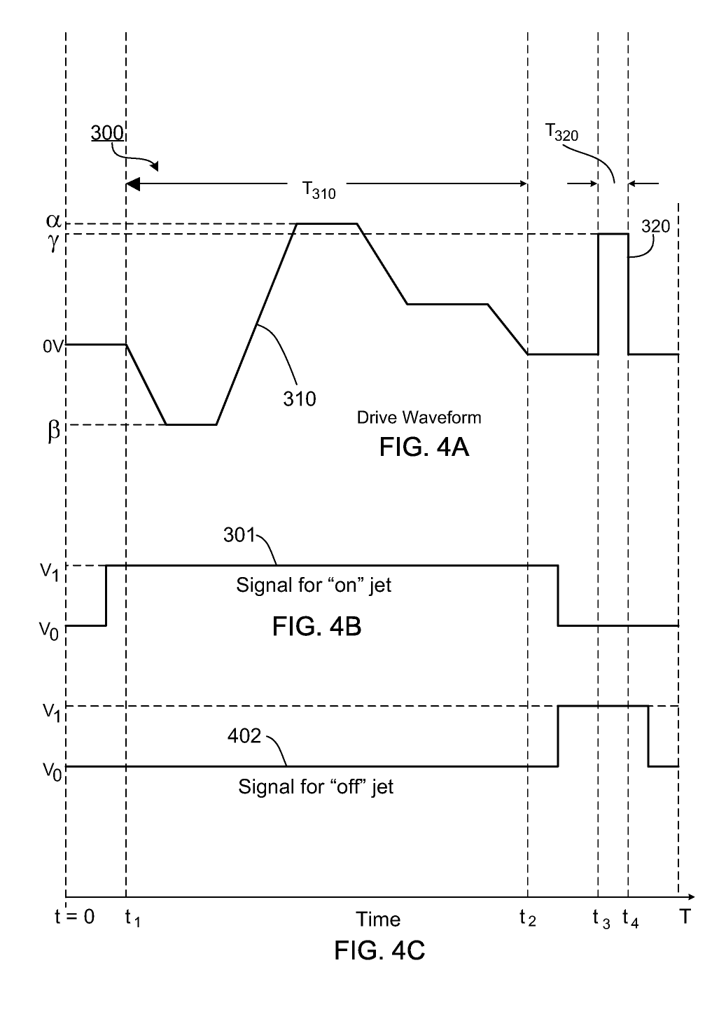

For example, referring to FIGS. 4A-4C, in some embodiments, an ink jet module can utilize the same drive waveform 300 as described above and shown in FIG. 3A, but with modified logic signals that activate jets for the tickle pulse only where the jet was inactive for the ejection pulse. As shown in FIG. 4B, the logic signal for “on” jets is the same as described above in relation to FIG. 3B. However, as shown in FIG. 4C, “off jet” logic signal 402 as at V₀ from t=0 until after t₂. At some time between t₂ and t₃, the signal switches to V₁, activating the jet prior to application of tickle pulse 320. As some time between t₄ and T, the signal switches from V₁ to V₀, deactivating the jet prior to the start of the subsequent jetting cycle.

The implementations described above utilize a single waveform which includes both an ejection pulse and a tickle pulse. More generally, however, implementations can include using different waveforms for the ejection pulse and tickle pulse.

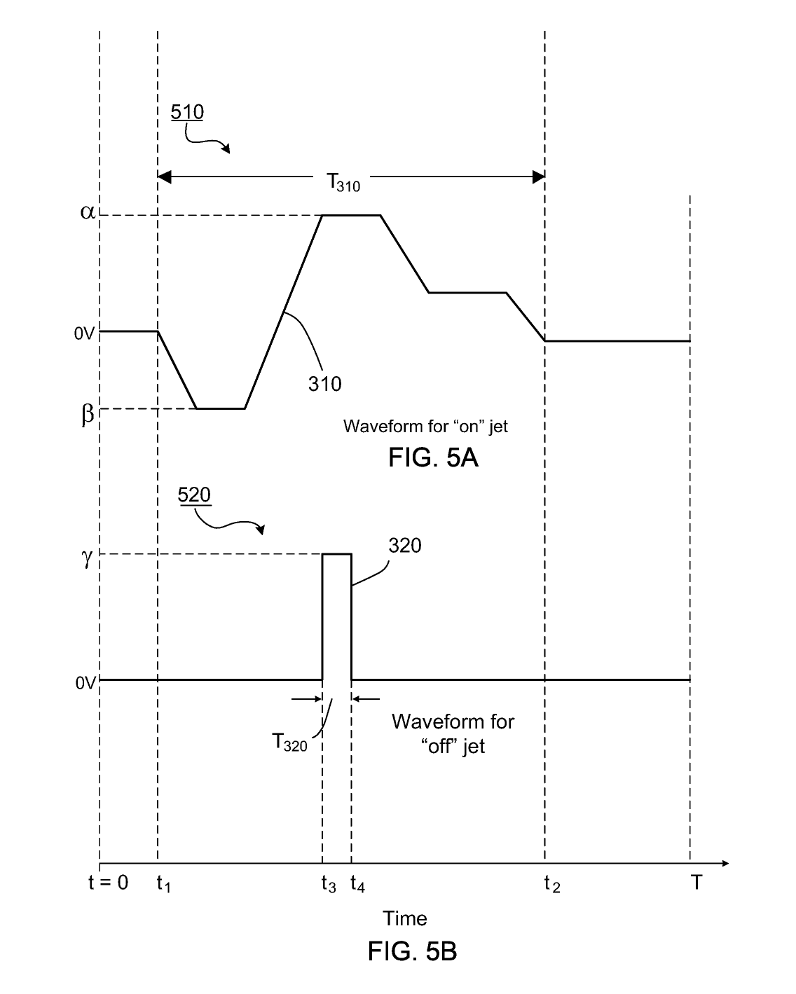

Referring to FIGS. 5A and 5B, for example, in some embodiments, each print cycle, an ink jet module can be driven with either a waveform 510 that includes an ejection pulse 310 but no tickle pulse, or a different waveform 520 that includes a tickle pulse 320 but no ejection pulse. Tickle pulse 320 can be applied to ink jets contemporaneously to applying ejection pulse 310 to other jets, as shown in FIGS. 5A and 5B, or can be applied non-contemporaneously.

In general, the design of the control circuitry used to generate the drive waveforms and to control delivery of the drive waveforms to individual jets may vary as desired. Typically, the drive waveform is provided by a waveform generating device such as an amplifier (or other electronic circuit) that outputs the desired waveform based on a lower voltage waveform supplied to the amplifier. Ink jet modules may utilize a single waveform generating device, or multiple devices. In some embodiments, each ink jet in an ink jet module can utilize its own individual waveform generating device.

Although the waveform shown in FIGS. 3A, 4A and 5A have a particular shape, in general, waveform shape can vary as desired. For example, ejection pulse 310 can be bipolar or unipolar. Pulse 310 can include triangular, rectangular, trapezoidal, sinusoidal, and/or exponentially, geometrically, or linearly varying portions. Similarly, pulse 320 can be bipolar or unipolar. Moreover, while pulses 320 are rectangular in the in FIGS. 3A, 4A, and 5A, in general, these pulses can include triangular, rectangular, trapezoidal, sinusoidal, and/or exponentially, geometrically, or linearly varying portions. Furthermore, while ejection pulses and/or tickle pulses can be more complex waveforms than those illustrated in FIGS. 3A-5B. For example, an ejection pulse may include multiple oscillations. Examples of ejection pulses that include multiple oscillations are described in U.S. Patent Application Ser. No. 10/800,467, entitled “HIGH FREQUENCY DROPLET EJECTION DEVICE AND METHOD,” filed on Mar. 15, 2004, the entire contents of which are hereby incorporated by reference. In some embodiments, a tickle pulse can include multiple oscillations.

In general, ink jet modules, such as ink jet module 12, can be used to jet a variety of fluids, such as various inks (e.g., UV curing ink, solvent-based ink, hot-melt ink) and or liquids, including liquids containing adhesive materials, electronic materials (e.g., electrically conductive or insulating materials), or optical materials (such as organic LED materials).

Furthermore, the jetting schemes discussed can be adapted to other droplet ejection devices in addition to those described above. For example, the drive schemes can be adapted to ink jets described in U.S. Patent Application Ser. No. 10/189,947,entitled “PRINTHEAD,” by Andreas Bibl and coworkers, filed on Jul. 3, 2003, and U.S. Patent Application Ser. No. 09/412,827, entitled “PIEZOELECTRIC INK JET MODULE WITH SEAL,” by Edward R. Moynihan and coworkers, filed on Oct. 5, 1999, the entire contents of which are hereby incorporated by reference.

A number of embodiments of the invention have been described. Nevertheless, it will be understood that various modifications may be made without departing from the spirit and scope of the invention. Accordingly, other embodiments in the claims.

1. A method of driving an inkjet module having a plurality of ink jets, the method comprising:
applying a voltage waveform to the inkjet module, the voltage waveform comprising a first pulse and a second pulse;
activating one or more of the ink jets contemporaneously to applying the first pulse, wherein each activated ink jet ejects a fluid droplet in response to the first pulse; and
activating all of the ink jets contemporaneously to applying the second pulse without ejecting a droplet.

2-19. (canceled)
